(19) United States
(12) Patent Application Publication
(10) Pub. No.: US 2025/0350147 A1
(43) Pub. Date: Nov. 13, 2025

(54) Multi-Link Backscattering Power Communications

(71) Applicant: TEXAS INSTRUMENTS INCORPORATED, Dallas, TX (US)

(72) Inventors: Yaron Alpert, Hod-Hasharon (IL); Brian P. Ginsburg, Allen, TX (US); Yoav Ben-Yehezkel, Netanya (IL)

(21) Appl. No.: 19/193,997

(22) Filed: Apr. 30, 2025

Related U.S. Application Data
(60) Provisional application No. 63/645,479, filed on May 10, 2024.

(51) Int. Cl. H02J 50/00; H02J 7/00; H04L 5/00; H04W 52/02

(52) U.S. Cl. CPC H02J 50/001; H02J 7/0047; H04L 5/0053; H04W 52/0274

(57) ABSTRACT

A system includes an electronic device that is configured to transmit first energy and first data over a first link and to transmit second energy and second data over a second link. The system also includes another electronic device that is configured to receive the first energy and the first data over the first link and to receive the second energy and the second data over the second link. The first link and the second link may be configured to be synchronized or unsynchronized, and the communications may be in joint mode or duplicate mode.

### CROSS-REFERENCE TO RELATED APPLICATIONS

The present application claims the benefit of U.S. Provisional Patent Application 63/645,479, filed May 10, 2024, the disclosure of which is hereby incorporated by reference in its entirety.

### TECHNICAL FIELD

The present disclosure relates generally to an electronic system and method, and, in particular embodiments, to multi-link backscattering power communications.

### BACKGROUND

IEEE 802.11 (Wi-Fi), Long Term Evolution (4G), 5G, and 6G are examples of communication protocol standards that facilitate wireless data transmission over a radio link.

### SUMMARY

In accordance to an embodiment, an electronic device including: a communication interface; and a processor configured to: transmit first energy and first data over a first link, via the communication interface; and transmit second energy and second data over a second link, via the communication interface.

In accordance to an embodiment, an electronic device including: a communication interface; and a processor configured to: receive first energy and first data over a first link, via the communication interface; and receive second energy and second data over a second link, via the communication interface.

In accordance to an embodiment, an electronic device including: a communications circuit configured to receive first energy and first data over a first link and to receive second energy and second data over a second link; and an energy collection circuit configured to: harvest the first and second energy received by the communications circuit over the first link and the second link, and power the communications circuit using the harvested energy.

### BRIEF DESCRIPTION OF THE DRAWINGS

For a more complete understanding of the present invention(s), and the advantages thereof, reference is now made to the following descriptions taken in conjunction with the accompanying drawings, in which:

FIG. 1 illustrates a radio-frequency (RF) multi-link communication example between two devices, according to some embodiments;

FIG. 2 illustrates an exemplary communication between multi-link devices (MLDs) in duplicate mode with a synchronous multi-link, according to some embodiments;

FIG. 3 illustrates an exemplary communication between MLDs in joint mode with asynchronous multi-link, according to some embodiments;

FIG. 4 illustrates an exemplary low-power downlink for the Internet of Things using an IEEE 802.11-compliant wake-up receiver, according to some embodiments;

FIG. 5 illustrate examples of backscattering communication, according to some embodiments;

FIG. 6 illustrates a block diagram of a backscattering device, according to an embodiment of the present disclosure, according to some embodiments; and

FIGS. 7-14 show timelines of multi-link backscattering power communication 800, according to embodiments of the present invention, according to some embodiments;

FIG. 15 is an illustration of an example method 1500, according to some embodiments;

FIG. 16 is an illustration of an example method 1600, according to some embodiments;

FIG. 17 illustrates example scenarios, according to various embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present disclosure are described in specific contexts, e.g., multi-link energy and data transmission and reception, e.g., using a wireless communication protocol, such as Wi-Fi. Some embodiments may be implemented in other wireless communication protocols, such as Bluetooth Low Energy (BLE), Ultra Wideband (UWB), 3GPP (LTE, 5G, 6G), IEEE 802.15.4, and the like.

WiFi 7 (IEEE 802.11 be) describes baseline functionality for multi-link communication. With Multi-Link Operation (MLO), a client device can communicate with an access point (AP) over multiple radios and frequency bands at the same time. Thus, a Multi-Link Device (MLD) (e.g., the client device or an access point, AP) may communicate using MLO, which may advantageously result in higher throughput, reduced delays, reduced power consumption, and increased robustness.

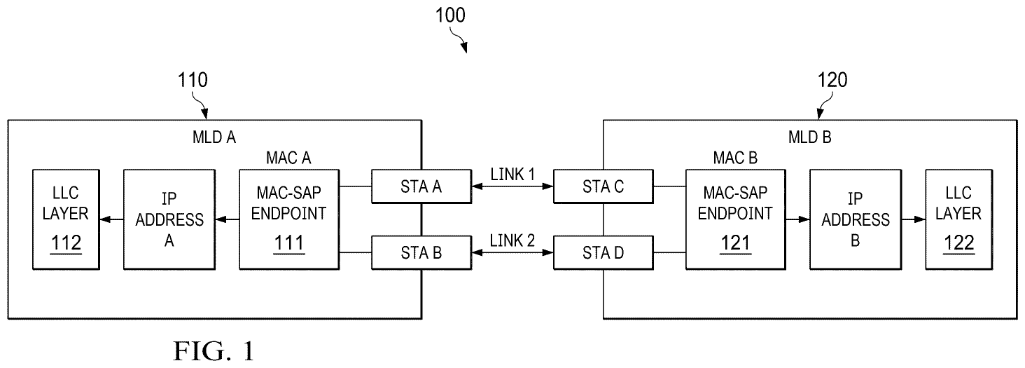

FIG. 1 is an illustration of example system 100, for multi-link communication, according to some embodiments. System 100 includes a first Multi-Link device A (MLD A) 110 and a second Multi-Link device B (MLD B) 120, which are both configured to communicate over links 1 and 2. More specifically, FIG. 1 illustrates an example of radio-frequency (RF) multi-link communication example between MLD A and MLD B.

A “link” may be understood as a communication link in which packets or frames may be sent and received. For instance, an example protocol may transmit frames that aggregate multiple packets, and those packets may include multiple fields or protocol data units. In another example, a single packet may be fragmented over multiple frames each carrying a different portion of the entire packet. While the term “packet” may be used in examples below, it is understood that various embodiments may be adapted to perform the same or similar actions with respect to other data structures, such as frames. Often a link corresponds to an RF link. Links 1 and 2 may both operate, for example, in the 2.4 GHz range. However, other scenarios are possible, such as both links 1 and 2 operating on the 5 GHz or on the 6 GHz range or other regulated operation bands. It is also possible for each of links 1 and 2 to operate in different frequency ranges. For example, link 1 may operate in the 2.4 GHz and link 2 may operate in the 5 GHz or 6 GHz. Other scenarios are also possible.

In the example of FIG. 1, each of the links is defined by a particular communication protocol such as, Bluetooth, Wi-Fi, UWB, 3GPP or the like. A link in MLO may refer to a logical connection between two or more devices (e.g., an AP or a Station (STA)) established on a specific channels set and frequency band, and each link may use a same protocol or a different protocol. In the present example, the links 1 and 2 may share parameters. One example parameter is a medium access control (MAC) address, where a single MLD MAC address may be shared across the links to enable unified identification of the MLD. In other words, MLD A 110 may have its own MAC address, and MLD B 120 may have its own, different MAC address, and both MLD A 110 and MLD B 120 may include their respective MAC addresses in packets as source or destination identifiers as appropriate.

Links 1 and 2 may share some or all of the following parameters in some embodiments. For instance, another parameter that may be shared between links 1 and 2 may include encryption keys, protocols (e.g., WPA 3), and other security settings. Yet another example parameter that may be shared between links 1 and 2 may include quality of service (QOS) and other traffic parameters, such as traffic identifiers (TIDs), Access categories (ACs), and traffic specifications (TSPECs). Furthermore, the links 1 and 2 may also share power management parameters, such as a unified power management mode (e.g., active or sleep) and wake time negotiation parameters. Links 1 and 2 may also share channel access and scheduling parameters, such as contention windows, arbitration inter-packets spaces (AIFSs), link selection policies, and the like. Links 1 and 2 may also share bandwidth and frequency information, such as operating class and channel bandwidth and operating channels parameters, such as information about primary and secondary channels for links 1 and 2. Links 1 and 2 may also share link metrics and status parameters, such as signal strength (e.g., RSSI), and other Link quality metrics, such as latency, packet error rate, and throughput. Links 1 and 2 may also share configurations for aggregate MAC protocol data unit (A-MPDU) and aggregate MAC service data unit (A-MSDU) and unified threshold parameters for packet fragmentation. Links 1 and 2 may also share beacon and probe responses that contain shared MLD capabilities and operational details as well as the ability to advertise supported MLO link capabilities to peer devices. Links 1 and 2 may also share data encryption parameters, such as shared encryption methods (e.g., cipher suites) and replay counters to prevent replay attacks. Links 1 and 2 may also share roaming and mobility parameters, such as a unified set of basic service set identifiers (BSSIDs) for each link within an MLD and may also share policies for handover between links or bands. Links 1 and 2 may also share unified retry parameters for packet transmission as well as for block acknowledgment (BA). Links 1 and 2 may also share packet ID (e.g., index), where a given packet may be sent on either link as-is.

As shown in FIG. 1, each of the affiliated Wi-Fi devices (e.g., STAs) may have a physical (PHY) interface to the wireless media, but only a single interface to the Logical Link Control (LLC) layer. For instance, MLD A 110 includes STAs A-B, and MLD B 120 includes STAs C-D, each of which includes a PHY interface. STAs A-B each maintain a respective link for MLD A 110 and also feed downstream to MAC endpoint 111, which communicates with LLC layer 112 using a single Internet protocol (IP) address (IP address A). Similarly, STAs C-D each maintain a respective link for MLD B 120 and also feed downstream to MAC endpoint 121, which communicates with LLC layer 122 using a single IP address (IP address B).

With MLD A 110, each of STAs A-B may include hardware, such as power amplifiers, filters, antennas, and the like, to transmit data over the air medium. Each of the STAs A-B may include a PHY interface, where the PHY interface corresponds to a physical layer in the OSI model and the IEEE 802.11 protocol stack. The PHY interface may provide for modulation, encoding, and signal transmission. Functionality of the PHY interface may be implemented using hardware logic and/or software executed by one or more processors. The MAC endpoint 111 may include a MAC layer entity corresponding to the MAC layer in the OSI model and the IEEE 802 11.protocol stack. The MAC endpoint 111 may provide functions including frame processing, MAC addressing, and access control. MAC endpoint 111 may be implemented using hardware logic and/or software logic executed by one or more processors. Continuing with the example of MLD A 110, the LLC layer 112 may correspond to the data link layer in the OSI model and the IEEE 802.11 protocols DAC. The LLC layer 112 may handle multiplexing of network protocols (e.g., IPv4, IPv6), error detection and control, and flow control. The functionality of LLC layer 112 may be provided by hardware logic and/or software executed by one or more processors. The functionality providing the PHY interface, the MAC endpoint 111, and the LLC layer 112 may be provided by a same hardware logic circuit, different hardware logic circuits, and one or multiple processors. MLD B 120 may be implemented the same as or similar to MLD A 110.

In one example, system 100 may operate according to a WiFi 7 protocol, which may support multiple modes of multi-link channel access, synchronous and asynchronous transmissions and multiple transmitter (TX) packet formations, duplicate mode and joint mode. In other words, system 100 may be configured to operate in synchronous and asynchronous mode as well as configured to operate in duplicate mode and joint mode. Thus, various embodiments may be advantageously adapted for use with various operating modes that are supported by various protocols.

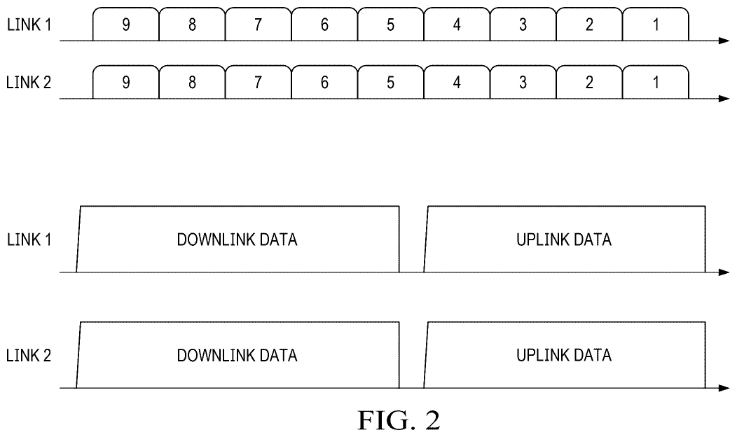

FIG. 2 illustrates duplicate mode, for which system 100 may be configured, according to some embodiments. In duplicate mode, a transmitter of an MLD (e.g., MLD A 110) sends copies of each packet over multiple links (e.g., links 1 and 2). Thus, FIG. 2 illustrates packets 1-9 being transmitted over both link 1 and link 2. Once a receiver of another MLD (e.g., MLD B) obtains a packet, it may drop all other copies that are delivered later.

FIG. 2 also illustrates synchronous mode, for which system 100 may be configured, according to some embodiments. In synchronous mode, links 1 and 2 may be used according to time domain and frequency domain data to allow the links to transmit at the same time, though using different channels or bands. For instance, in FIG. 2, link 1 and link 2 may include a downlink operation overlapping in time and include an uplink operation overlapping in time.

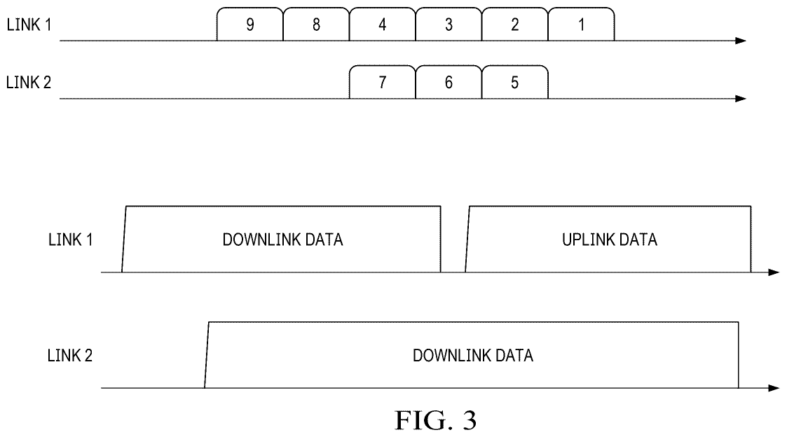

FIG. 3 illustrates joint mode, for which system 100 may be configured, according to some embodiments. In joint mode, a transmitter of an MLD (e.g., MLD A 110) distributes packets over available links without necessarily producing any duplicates. For instance, in FIG. 3 link 1 may transmit packets 1-4 and 8-9, whereas link 2 may transmit packets 5-7, with any particular packet not being duplicated among links 1 and 2. In joint mode, an MLD may divide a set of data into a first group of packets (e.g., packets 1-4 and 8-9) and a second group of packets (e.g., packets 5-7) and transmit the first and second groups over different links.

FIG. 3 also illustrates asynchronous mode, for which system 100 may be configured, according to some embodiments. In asynchronous mode, links 1 and 2 may be used according to time domain and frequency domain parameters to allow the links to transmit at any particular time, such that uplink and downlink operations may not necessarily be synchronized in the time domain. In an example in which both energy and data are transmitted among links 1 and 2, asynchronous mode may include misalignment between energy and data in the time domain. Similarly, in an example in which both energy and data are transmitted among links 1 and 2, synchronous mode may include alignment between energy and data in the time domain.

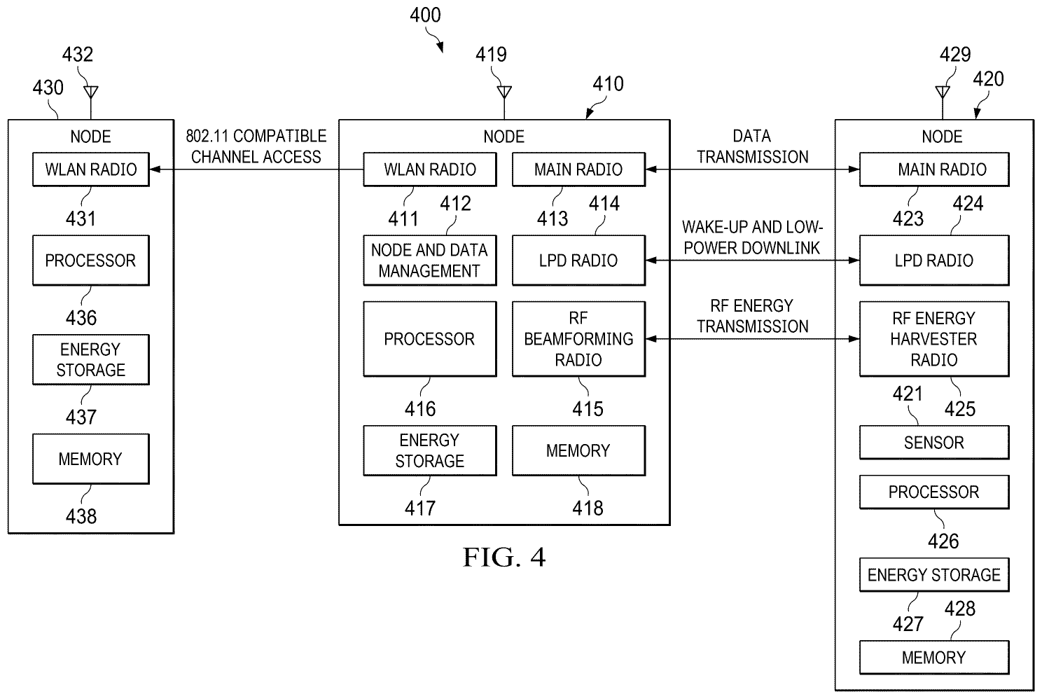

FIG. 4 illustrates an example system 400, for powering communications using energy harvesting, according to some embodiments. System 400 includes node 410, node 420, and node 430. Either or both of the MLDs 110, 120 of FIG. 1 may be configured as node 410, node 420, or node 430.

As shown in FIG. 4, RF energy may be transmitted by an AP (e.g., node 410) in a dedicated link that is separate from the data transmission link. Such energy may be harvested by a sensor node (e.g., node 420) using backscattering.

Node 410 may be configured to operate according to any appropriate communications protocol such as Wi-Fi, BLE, UWB, or the like. In this example, node 410 provides an exemplary low-power downlink for node 420, which is configured as an Internet of Things IEEE 802.11-compliant wake-up receiver.

Node 420 includes main radio 423, low-power downlink (LPD) radio 424, RF energy harvester radio 425, energy storage circuit 427, and memory 428. Each of the radios 423-425 may include functionality to implement the OSI layers of a given protocol stack. Such functionality may be implemented in hardware logic and/or software executed by a processor 426. For instance, each of the radios 423-425 may include its own hardware logic or its own processor core or may share hardware logic and processor 426 with other ones of the radios 423-425. In one example, memory 428 may include computer-readable instructions to be executed to provide the functionality of OSI layers as well as application-layer functionality. Energy storage component 427 may include a battery, capacitor, or other appropriate component to store energy (e.g., from RF energy harvester radio 425) and to provide that energy to the radios 423-425 during operation. Antenna 429 is shown as a single antenna, though it is understood that antenna 429 may include a single antenna or an array of multiple antennas. In one example, each of the radios 423-425 may include its own antenna or antenna array. In another example, the radios 423-425 may share a single antenna or antenna array. In the case of an antenna array, a given one or all of the radios 423-425 may use the antenna array for directionality, such as by beamforming.

Node 410 includes radios 411 and 413-415. Each of the radios 411 and 413-413 may include functionality to implement the OSI layers of a given protocol stack. Such functionality may be implemented in hardware logic and/or software executed by a processor 416. Each of the radios 411 and 413-415 may include its own hardware logic or processor or may share hardware logic or processor 416 with others of the radios 411 and 413-415. Software may be implemented in computer-readable instructions stored to memory 418. Antenna 419 may be a single antenna or an array of antennas, and each radio 411 and 413-415 may include its own antenna or antenna array. In another example, the radios 411 and 413-415 may share an antenna or antenna array.

Node 430 includes WLAN radio 411, which may include functionality to implement the OSI layers of a given protocol stack. Once again, such functionality may be implemented in hardware logic and/or software executed by a processor 436. In an example which uses processor 436, the processor 436 may read computer-readable instructions stored to memory 438. Antenna 432 may be a single antenna or an array of antennas.

Nodes 410 and 420 include respective main radios 413, 423, which are configured to transmit data on the uplink and downlink. Nodes 410 and 420 also include respective low-power downlink (LPD) radios 414, 424, which may provide downlink communications for wake-up signals and other data. Furthermore, nodes 410 and 420 include respective radios 415, 425 for beam forming and energy harvesting. For instance, RF beamforming radio 415 may be configured to use beamforming techniques (either in an open or closed loop) to transmit packets or other signals that may be harvested for energy by RF energy harvester radio 425. Examples of signals that may be harvested for energy include data signals, null or empty packets, data packets, and/or the like.

Backscatter communication may exploit the reflected or backscattered signals to provide energy that may be used to transmit data, where the backscattered signals may be the reflection of ambient radio frequency (RF) signals, the RF signals from the dedicated carrier emitter, or signal photons in non-classical quantum entangled pairs, etc. In the present example, the signals from RF beamforming radio 415 are employed as the backscatter communications, which are harvested for energy by the RF energy harvesting radio 425.

Radios 413, 423 may be configured to have an established communication link, such as link 1 of FIG. 1, and radios 415, 425 be configured to have an established communication link, such as link 2 of FIG. 1. Such established communication links may be bidirectional or may be downlink-only (e.g., from node 410 to node 420).

In some examples, node 420 may harvest energy, via RF energy harvester radio 425, sufficient to receive signals by LPD radio 424 and to transmit and/or receive data via main radio 423. In this example, node 410 may include a relatively large energy storage source component 427 (e.g., battery and/or capacitor), sufficient to provide always-on or nearly always-on operation, and the same may or may not be true of node 430 (e.g., energy storage component 437). Furthermore, in this example, node 420 may have a relatively small energy storage source and may rely on energy harvesting for some or all of its energy.

In one example use case, node 420 may be a sensor node, and node 410 may be a deployed monitoring access point to communicate with multiple sensor devices. For instance, node 420 may include a sensor 421, which may be configured to detect any appropriate phenomenon, such as temperature, humidity, air quality, and/or the like. Processor 426 may include functionality to cause main radio 423 to transmit sensor data to node 410. Furthermore, in the example use case, node 410 may also be configured to communicate with node 430, e.g., by aggregating data from multiple sensor nodes and transmitting that aggregated data to node 430. Continuing with the example use case, nodes 410 and 430 may communicate via respective radios 411, 431. Node 410 may include computer-readable instructions in memory 418 to cause the node and data management module 412 to provide the sensor communications described above. However, the scope of implementations may include other use cases in addition to, or instead of, deployed IOT sensors.

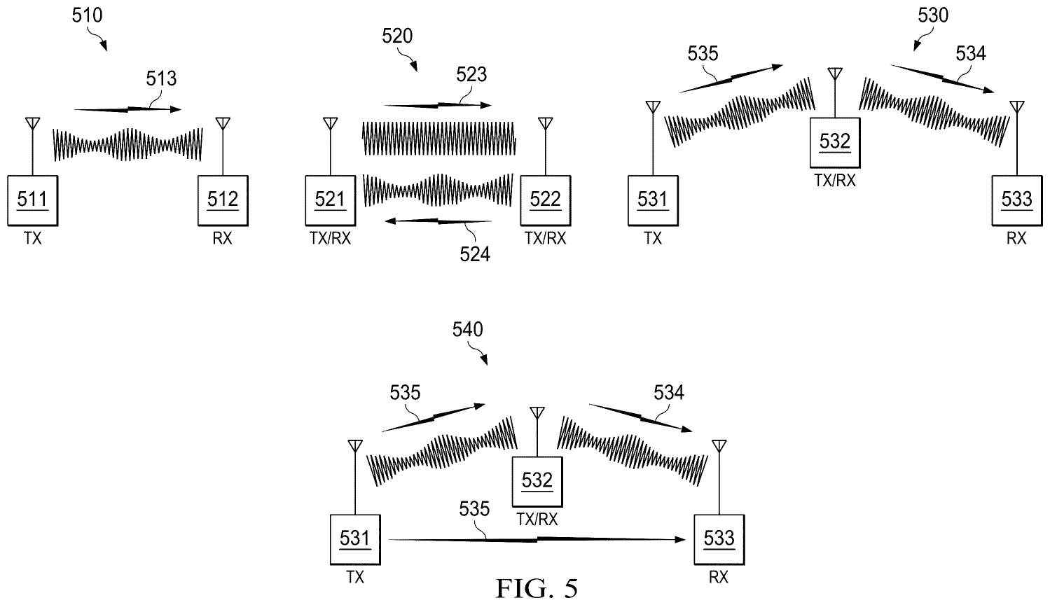

FIG. 5 illustrates examples of backscattering communication, for which the MLDs 110 and 120 of FIG. 1 may be configured, according to some embodiments. As shown in scenario 510, energy and data may be transmitted over the same link 513, between devices 511 and 512. As shown in scenario 520, energy may be transmitted over link 523, and data may be received over link 524 between devices 521 and 522. For example, link 523 may include a carrier wave or empty packets, whereas link 524 may include data packets. As shown in scenario 530, energy and data may be transmitted from device 531 to device 532 via link 535, and data may be transmitted from device 532 to device 533 via link 534. As shown in scenario 540, the radiation or incident signal at one of the multi-link frequencies may be used as energy to transmit information at another multi-link frequency delivered to another communication receiver (passive or third device) and/or back to the original energy transmitter.

In one example use case, devices 522 and 532 may include tags, such as BLE or RFID tags, though the scope of implementations may include any appropriate use case, such as may use Wi-Fi, UWB, or other protocol.

Some embodiments use one or more of the Multi-Link frequency signals as a source of energy, such as illustrated in scenarios 520 and 530. A backscattering IOT device (e.g., device 522 or 532) may absorb RF energy from the backscattering transmitter (e.g., device 521 or 531) and may turn the energy into DC power to charge an energy storage (e.g., supercapacitor or battery, not shown). The IOT device may then use the stored energy to transmit data to either the original transmitter (e.g., device 531) or another device (e.g., device 533). The device that harvests energy may then use that energy to transmit data and may be configured as an active device, a semi-passive device, and/or a passive/active device. Some embodiments may provide a regular and real-time controllable energy source at any regulated multi-link operation band.

In scenario 540, the link 535, which provides energy, may also be received by device 533, and device 533 may be configured to perform energy harvesting in a similar manner as device 532. Thus, device 533 may use harvested energy to receive data transmitted via link 534, and device 532 may use harvested energy to transmit data via link 534.

As a result, some embodiments advantageously enable a robust, low-cost, and scalable way to provide power and enable IoT devices' communication sensing and operation.

In some embodiments, the multi-link backscattering timing, control, and synchronization may advantageously enable increasing the range between the transmitter (e.g., devices 511, 521, or 531) and the IoT device (e.g., device 512, 522, 533) and/or provide higher data rates with higher-order modulation that may be leveraged to increase throughput or reduce power consumption. Furthermore, the multi-link backscattering timing, control, and synchronization may advantageously enable a system to control the energy provided by transmissions to increase the potential energy collected by the backscatter transmitter. For instance, a first device (e.g., device 512, 522, or 533) may have an open-loop control mechanism established with a second device providing energy (e.g., device 511, 521, or 531), allowing the first device to provide feedback to the second device. The second device may use that feedback to then increase or decrease its transmitting energy, select a particular beam to use, and/or the like.

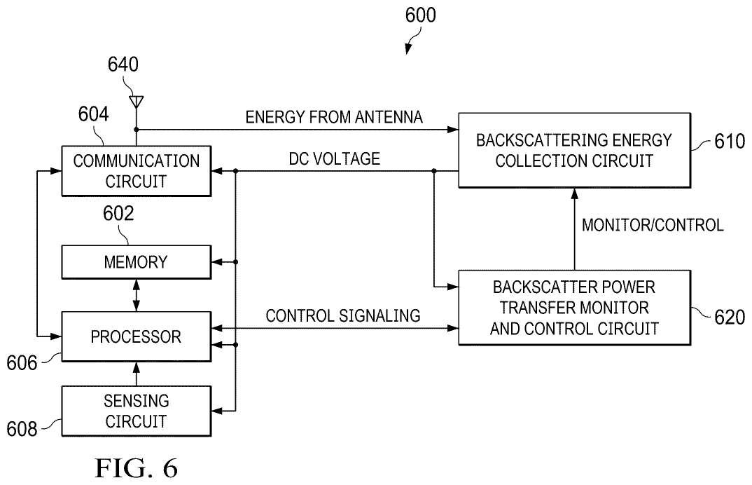

FIG. 6 illustrates a block diagram of backscattering device 600, according to some embodiments. For instance, each of the MLDs 110 and 120 of FIG. 1 may be configured the same as or similar to device 600. Backscattering device 600 includes memory 602, backscattering energy collection circuit 610, backscatter power control monitor and control 620, and antenna 640. Device 600 also includes communication circuit 604, processor 606, and sensing circuit 608. Antenna 640 may include a single antenna or an array of multiple antennas.

Communication circuit 604 may include functionality to implement the OSI layers of a protocol stack, such as for Wi-Fi, 3GPP, and/or the like. The functionality may be provided by hardware logic, software executed by processor 606, or a combination thereof. More specifically, communication circuit 604 may be configured to transmit and receive data via antenna 640. Further, communications circuit 604 may be configured to transmit and receive energy and data on multiple communication links, such as described above with respect to FIG. 1.

Processor 606 may include any appropriate processor, such as a microprocessor unit, a central processing unit (CPU), a reduced instruction set computer, a system on-chip (SOC), or the like. Processor 606 is coupled to memory 602, which may be implemented as any appropriate random-access memory, such as static RAM (SRAM), dynamic RAM (DRAM), or the like. Memory 602 may store computer-readable instructions, which may be read and executed by processor 606. In one example, processor 606 may include computer-readable instructions that, when executed by processor 606, causes processor 606 to collect data from sensing circuit 608, process that data if appropriate, and relay that data to another device via communication circuit 604.

Sensing circuit 608 may be implemented as any appropriate sensing unit, such as sensing unit that measures temperature, humidity, light, sound, vibration, or any other environmental phenomenon. Sensing circuit 608 may be coupled to processor 606, thereby allowing processor 606 to collect data from sensing circuit 608.

Backscattering energy collection circuit 610 may be coupled to antenna 640 and may be configured to harvest energy from RF signals received via antenna 640. Circuit 610 may be implemented in any appropriate manner, such as including a rectifier to harvest energy and a capacitor to store the harvested energy. Circuit 610 may output the harvested energy as a DC voltage, where that DC voltage may be provided to the other components of device 600, such as communication circuit 604, memory 602, processor 606, sensing circuit 608, and backscatter power transfer monitor and control circuit 620.

Backscatter power transfer monitor and control circuit 620 may be implemented in some examples by hardware logic. Device 600 may be implemented on a semiconductor chip for multiple semiconductor chips as appropriate.

Circuit 620 may be configured to monitor the activity of circuit 610 and also an amount of energy stored by circuit 610. For instance, circuit 620 may be configured to turn energy harvesting on or off based on determining that an amount of energy stored by circuit 610 is above or below one or more set thresholds. Circuit 620 may also be configured to determine whether an amount of energy being harvested is sufficient to provide a desired operation of device 600. For instance, circuit 620 may compare a rate of energy being harvested to one or more set thresholds. Should the rate of energy being harvested be less than a set threshold, then circuit 620 may attempt to cause a backscatter transmitter to change behavior.

In one example, the circuit 620 may provide control signaling, based on its monitoring, to processor 606. The control signaling may cause processor 606 to transmit control signals (via communication circuit 604) to a backscatter transmitter. In some embodiments, the control signaling may include instructions to increase or decrease the power level in energy transmission, timing of the energy transmission, intensity, frequency, duration, start/end of the energy transfer, spatial information, such as beamforming information, and/or information about capabilities of device 600 (e.g., target energy to be received, expected active versus sleep time, maximum amount of power to be received, etc.). The transmitted control signals may be received and acted upon by the backscatter transmitter (e.g., MLD A 110 of FIG. 1). In some embodiments, the backscatter transmitter may use the received control signals to adjust beamforming and power transmission levels, timing, and durations, and/or other energy transmission parameters to optimize energy transmission to device 600. For example, in some embodiments, the backscatter transmitter may select which link to use to transmit energy based the received control signals (e.g., since energy transmission may vary based on which frequency is used for transmission).

In some embodiments, circuit 620 may support forward link (e.g., uplink) and reverse link (e.g., downlink) signaling that may include: (1) control of the backscattering parameters (e.g., intensity, frequency, duration, start/end of the energy transfer); (2) closed loop feedback (e.g., power level control, spatial information feedbacks, such as beamforming); (3) flow control (e.g., buffering, timing, duty-cycle); and (4) discovery and capability information (e.g., whether the device supports multi-link energy harvesting).

During operation, backscattering device 600 may receive RF energy via multi-link operation from another MLD (not shown) via antenna 640. Once the circuit 620 determined that the DC voltage provided by power management circuit 610 is higher than a predetermined threshold, circuit 620 may cause device 600 may transition from a harvesting state to an active state. In the active state, device 600 may transmit and receive data using communication circuit 604 via antenna 640, operate sensing circuit 608 to collect sensing data, and process data (e.g., from communication circuit 604 or sensing circuit 608 using processor 606).

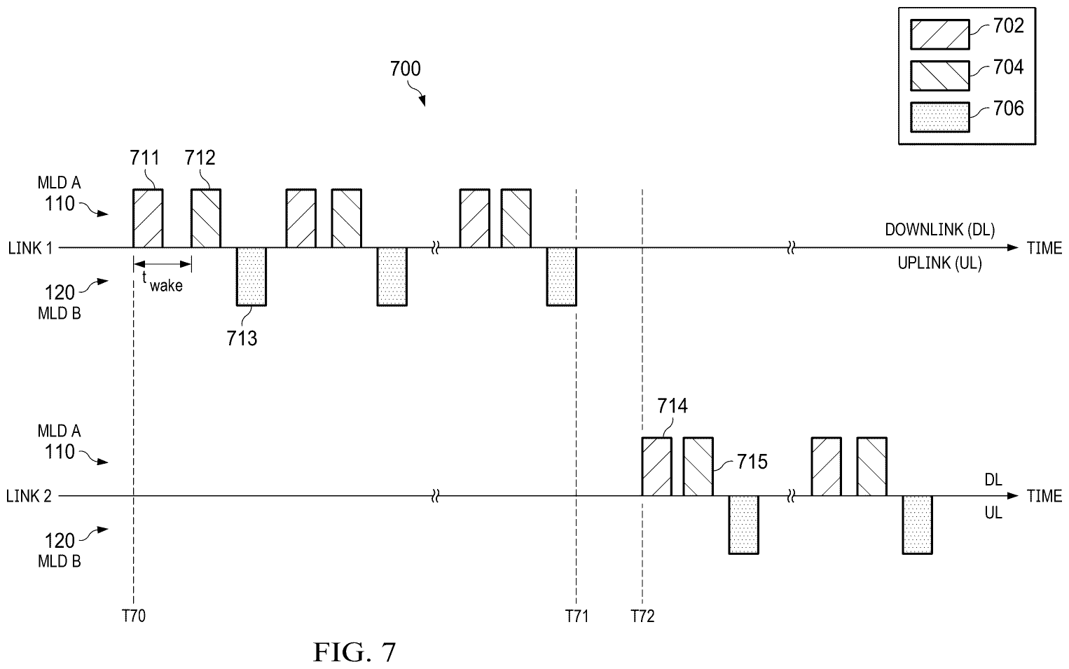

In some embodiments, energy and data are exchanged using multiple links while still complying with regulations and protocols that limit the amount of data/power transmission. A potential advantage of some embodiments may include the ability to transmit energy, receive energy, and control the energy transmission without interfering with data communication. For instance, embodiments that comply with regulations and protocols for transmitting energy via packets may do so by minimizing or eliminating unwanted effects on data transmission. Thus, in some examples (e.g., in FIGS. 7-14) MLDs may transmit and receive energy on multiple links by using frequency domain, time domain, and spatial domain parameters to coordinate that energy transmission with data transmission.

FIGS. 7-14 each show a timeline of multi-link backscattering power communication, according to various embodiments. In the examples of FIGS. 7-14, the multi-link backscattering power communication operations may be performed by devices, such as MLD A 110 and MLD B 120 of FIG. 1. More specifically, in these examples, MLD A 110 is illustrated as an access point or other device that may be configured to provide downlink communications to MLD B 120, and MLD B 120 may be configured to provide uplink communications to MLD A 110. The examples may be performed according to any appropriate protocol, such as Wi-Fi, Bluetooth, 3GPP, IEEE 802.15.4, and/or the like. Furthermore, in the examples of FIGS. 7-14, each MLD may be configured according to the example of FIG. 6.

Furthermore, each of the examples in FIGS. 7-14 includes the MLD A 110 employing time domain, frequency domain, and/or spatial domain parameters to transmit and receive both data and power (separately, simultaneously or partially overlapped), and the MLD B 120 employs time domain, frequency domain, and/or spatial domain parameters to receive both data and power (separately, simultaneously or partially overlapped), and to transmit data. An example of a time domain parameter may include a timing offset, a wakeup time, a starting time for transmitting energy or data, or other parameters related to timing of actions with respect to link 1 or link 2. An example of a frequency domain parameters may include channel, frequency band, and the like. For instance, a frequency domain parameter may include a channel hopping parameter or other parameter that identifies a particular channel to be used by a particular link at a particular time. In some embodiments, the selection of which link to use for energy and data exchange may be predetermined (e.g., according to a hopping sequence). An example of a spatial domain parameter may include a choice of antenna, beamforming parameters, and/or the like.

In one example, such time domain and frequency domain parameters may be pre-programmed into one or more of the MLD A 110 or MLD B 120. In another example, MLD A 110 and MLD B 120 may negotiate to set the time domain and frequency domain parameters, such as in one or more exchanges of control data previous to each of the multi-link backscattering power communications illustrated in FIGS. 7-14. Other parameters may be pre-programmed and/or negotiated, such as encryption techniques, encryption keys, power level for transmission, and the like. Time domain parameters and frequency domain parameters, as they may relate to transmitting and receiving energy and data, and as they may relate to each of the links 1 and 2, may be set to cause behavior by MLD A 110 and MLD B 120, as illustrated in FIGS. 7-14.

Also, various embodiments may include the MLD A 110 advertising its ability to transmit both energy and data on multiple links and/or the MLD B 120 advertising its ability to receive both energy and data on multiple links. In such examples, the advertising may be performed before the multi-link backscattering power communications illustrated in FIGS. 7-14.

Further in the examples of FIGS. 7-14, the MLD A 110 and the MLD B 120 may exchange measurement and/or control signals to allow for adaptive and dynamic action. For instance, MLD B 120 may measure signal quality or energy reception quality for one or both links and then transmit signal quality data to MLD A 110 either during the backscattering power communication or after the backscattering power communication. The MLD A 110 may use the signal quality data to adjust beamforming, transmit power, or other parameter in response. Such embodiments may advantageously allow for more efficient operation, such as by configuring MLD B 120 to affect the transmit signal to allow MLD B 120 to harvest more energy from the transmit signal. Such efficiency may allow for use of a smaller energy storage circuit (e.g., capacitor or battery) and longer intervals between energy harvesting.

In the examples of FIGS. 7-14, the energy packets 702 may conform to a particular communication protocol in use by MLD A 110 and MLD B 120. Examples of such communication protocols may include BLE, Wi-Fi, UWB, and the like. For instance, in one example, the energy packets 702 may include no-operation (NOP) packets, packets having a payload with dummy data, where the dummy data may include padding, packets with empty payloads, packets having data but not useful data (e.g., all ones, all zeros, alternating ones and zeros). In some examples, the energy packets may also include useful data and additionally include dummy data. In some examples, the energy packets 702 may not be formed as packets, but may rather be unmodulated carrier waves transmitted according to time domain and frequency domain restrictions of a communication protocol. In some embodiments, the energy packets may be identical over multiple transmissions. For instance, the same dummy data or unmodulated carrier wave may be used over multiple transmissions, thereby reducing complexity of the system. Furthermore, a potential advantage of such embodiments may include that an MLD receiving the energy packet may be pre-programmed to ignore such packets for processing, instead allowing such packets to skip decoding and processing. As a result, such systems may increase efficiency by avoiding using processing resources on energy packets. However, other embodiments may use energy packets that are different, such as by varying in length or type of dummy data, which may advantageously allow for more flexibility in operation.

Furthermore, in some embodiments, MLD B 120 may be configured to provide no acknowledgment (e.g., no ACK packet) after having received transmitted energy, thereby advantageously reducing a quantity of transmissions and reducing power used by the MLD B 120. However, the scope of embodiments may include MLD B 120 providing an acknowledgment packet after having received transmitted energy as appropriate. Furthermore, whether acknowledgment is provided for energy packets, various embodiments may provide acknowledgment for data packets. For example, one or more uplink data packets 706 may acknowledge receipt of a downlink data packet 704, and one or more downlink data packets 704 may acknowledge one or more uplink data packets 706.

In some embodiments, MLD B 120 may return to the harvesting/sleep/off mode after a data and energy exchange and then wake up at a later time for a subsequent data and energy exchange according to a pre-programmed time or other trigger.

Some implementations may advantageously adapt the concepts described herein into various networks. In some embodiments, energy and data exchange may be performed in a peer-to-peer communication. In some embodiments, energy and data exchange may be performed in other network topologies, such as star or mesh. In some instances, the communication exchange on a first link (e.g., link 1) may be conducted according to a same protocol as the communication exchange on the second link (e.g., link 2). In other instances, the communication exchanges on the first link and the second link may be performed according to different protocols (e.g., Wi-Fi and BLE, Wi-Fi and 3GPP, IEEE 802.15.4, Wi-Fi and UWB).

In the examples of FIGS. 7-14, the actions described with respect to packets may be adapted for use with frames, such as in a Wi-Fi implementation. For instance, in FIG. 7, various ones of the packets may be aggregated in a frame. In one example, packets 711 and 712, among others, may be aggregated in a frame. Similarly, packets 711 and 712 may be in different frames. Furthermore, downlink packets from multiple links may be aggregated into a single frame (e.g., MAC layer) or be in different frames.

In some embodiments, the uplink transmissions (e.g., 706) may be used for feedback, such as to provide data that may be used for adjusting or setting time domain parameters, frequency domain parameters, spatial domain parameters, and/or the like. Also, in some embodiments, the uplink transmissions (e.g., 706) may be used for transmission reception or energy reception acknowledgment (e.g., ACK or Block-ACK aggregating ACKs for multiple packets) when appropriate, such as to acknowledge receipt of data and on received energy.

Although FIGS. 7-14 show two links, it is understood that multi-link communication may be adapted to occur over more than two links. Furthermore, the links shown may be separated in a spatial domain or overlapped in a spatial domain.

FIG. 7 shows a timeline of multi-link backscattering power communication 700, according to some embodiments.

As shown in FIG. 7, MLD A 110 may transmit energy packet(s) 702 followed by data packet(s) 704. MLD B 120 may receive the energy packet(s) 702, generate voltage (using circuit 610) and provide the voltage (using 610) to other circuits of MLD B (604, 606, 608, and 620). Once powered, MLD B receives data packet(s) 704 via communication circuit 604, and processes the data packets using processor 606. MLD B 120 then may send data packet(s) 706, e.g., containing sensor data (e.g., from 608) or control messages (e.g., from 620). The exchange of energy and data (e.g., by packets 702, 704, 706) may be repeated one or more times in link 1. Then, the exchange of energy and data (e.g., by packets 702, 704, 706) may be performed in link 2.

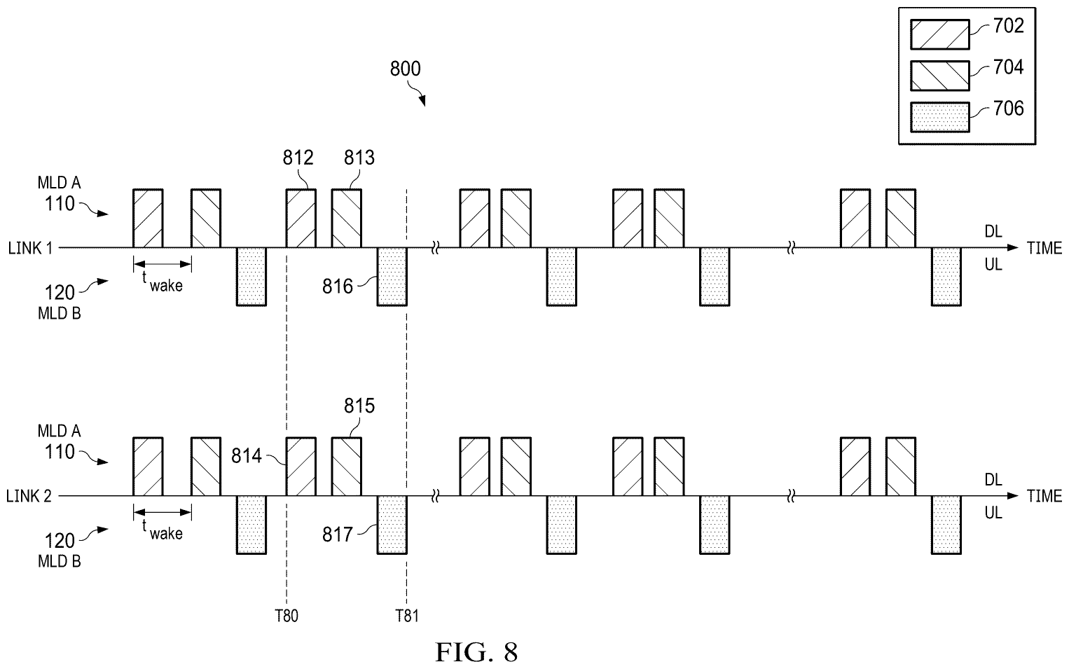

As shown in FIG. 7, in some embodiments, only a single link is used for energy and data exchange at a time. For instance, the MLD A 110 is configured to transmit the energy and data over link 1 without overlapping in the time domain with transmitting the energy and data over link 2. In the present example, the MLD A 110 is configured to transmit energy and data over link 1 before transmitting energy and data over link 2, at least in the slice of time illustrated in FIG. 7. Link 1 and link 2 may use the same or different frequency band or channel (e.g., may overlap in the frequency domain). By contrast, the examples of FIGS. 8-14 may include separation the frequency domain (e.g., different channels or different frequency bands for the links).

In some embodiments, during transmission of the first energy packet(s) 702, MLD B 120 is off. MLD B 120 may wake up once sufficient energy is harvested from first energy packet(s). However, MLD B may not be able to process the first data packet(s) 704 if MLD B has not finished waking up.

FIG. 7 illustrates a first communication exchange, which begins at time T70 and ends at time T71 as well as a second communication exchange, which begins at time T72. During the first communication exchange, MLD A 110 transmits energy packets (e.g., packets 711) and data packets (e.g., 712) on link 1, and those energy packets and data packets are received by MLD B 120. Similarly, MLD B 120 may transmit data packets (e.g., 713), and MLD A 110 may receive the data packets (e.g., 712) on link 1. The second communication exchange, which begins at time T72, includes similar activity by both MLD A 110 and MLD B 120 transmitting and receiving energy and data on link 2. As time goes on, communication exchanges may occur on one link at a time.

In some embodiments, a predetermined wake up time (t_{wake}) is used such that the first data packet(s) 712 is only transmitted after the predetermined amount of time to allow for MLD B to wake up. In an example, data or energy or combined data and energy packets 711 and 712 may be a same packet that is either fragmented or aggregated in the time domain, starting with wakeup and after wakeup the data is sent. The same may be true of any of the examples illustrated in FIGS. 7-14.

In some embodiments, the wake up time (t_{wake}) is negotiated between MLD A and MLD B during a previous energy and data exchange.

As shown in FIG. 7, the wake up time t_{wake} may only be used for the first energy and data exchange, and may not be used for subsequent energy and data exchange in the same or other links (e.g., the time between 714 and 715 in the other exchanges may be shorter or longer than between 711 and 712).

In some embodiments, the wake up time t_{wake} may be the same in each energy and data exchange (e.g., time between 714 and 715) may be the same in all energy and data exchanges. However, in other embodiments, the wake up time t_{wake} may be different if appropriate.

The other exchanges, illustrated in FIGS. 8-14, may use a wakeup time in a same or similar manner as that described with respect to FIG. 7.

FIG. 8 shows a timeline of multi-link backscattering power communication 800, according to some embodiments. Multi-link backscattering power communication 800 operates in a similar manner as multi-link backscattering power communication 700. Multi-link backscattering power communication 800, however, exchanges energy and data over links 1 and 2 in a duplicate mode with overlap in the time domain.

As shown in FIG. 8, energy packet(s) 702 are transmitted simultaneously over links 1 and 2. Data packet(s) 704 are transmitted simultaneously over links 1 and 2. And data packet(s) 706 are transmitted simultaneously over links 1 and 2. For instance, an example communication exchange is illustrated between times T80 and T81. During the communication exchange, MLD A 110 transmits an energy packet 812 on link 1 and an energy packet 814 on link 2 overlapping in the time domain. The same is true for the instances of the data packets 813 and 815. MLD B 120 may transmit a data packet 816 on link 1 overlapping in time with transmitting a data packet 817 on link 2. Further communication exchanges are illustrated and operate in a similar manner. In the example of FIG. 8, links 1 and 2 may use different channels that do not interfere.

In some embodiments, the data exchanges over links 1 and 2 shown in FIG. 8 may not be in duplicate mode and instead may be in joint mode.

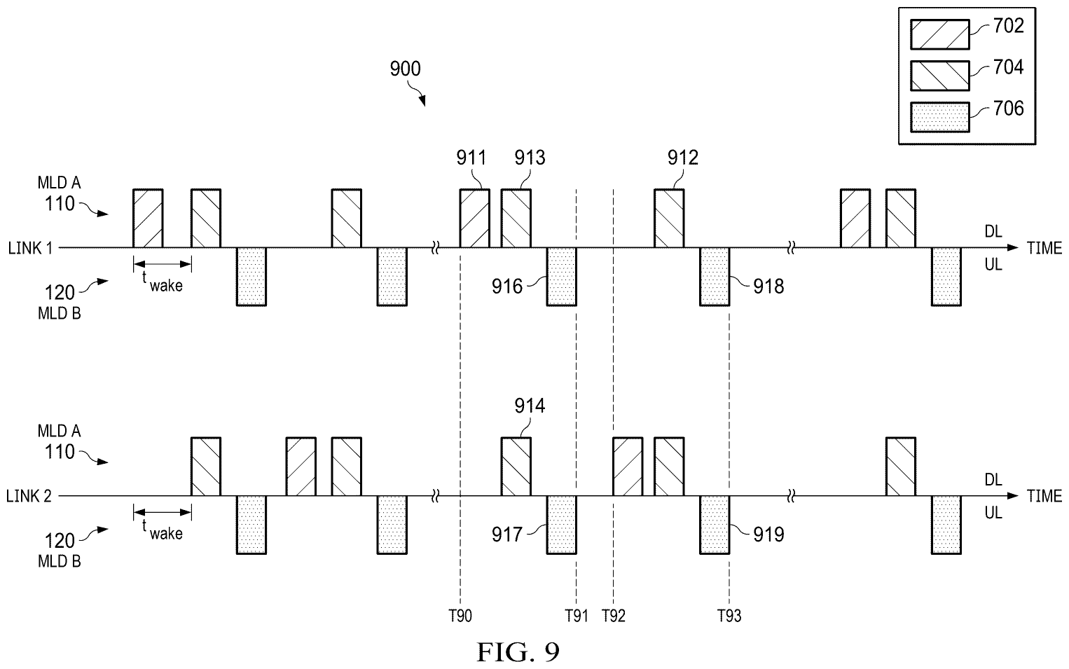

FIG. 9 shows a timeline of multi-link backscattering power communication 900, according to some embodiments. Multi-link backscattering power communication 900 operates in a similar manner as multi-link backscattering power communication 800. Multi-link backscattering power communication 900, however, exchanges energy over one link at a time, while data may be exchanged in both links, e.g., overlapping in the time domain.

As shown in FIG. 9, energy packet(s) 702 are not transmitted simultaneously over links 1 and 2, and instead, alternate between links 1 and 2. Data packet(s) 704 are transmitted simultaneously over links 1 and 2. And data packet(s) 706 are transmitted simultaneously over links 1 and 2. For instance, FIG. 9 illustrates a first communication exchange between times T90 and T91 and a second communication exchange between times T92 and T93. For the first communication exchange, there is a first energy packet 911, transmitted by MLD A 110 on link 1. The next an energy packet 912, transmitted by MLD A 110, is during the second communication exchange and on link 2. In both the first and second communication exchanges, MLD A 110 transmits data packets 913 and 914 overlapping in the time domain on links 1 and 2, and MLD B 120 transmits data packets 916-919 overlapping in the time domain on links 1 and 2 as well.

In some embodiments, the data exchanges over links 1 and 2 shown in FIG. 9 are in duplicate mode. In some embodiments, the data exchanges over links 1 and 2 shown in FIG. 9 may not be in duplicate mode and instead may be in joint mode.

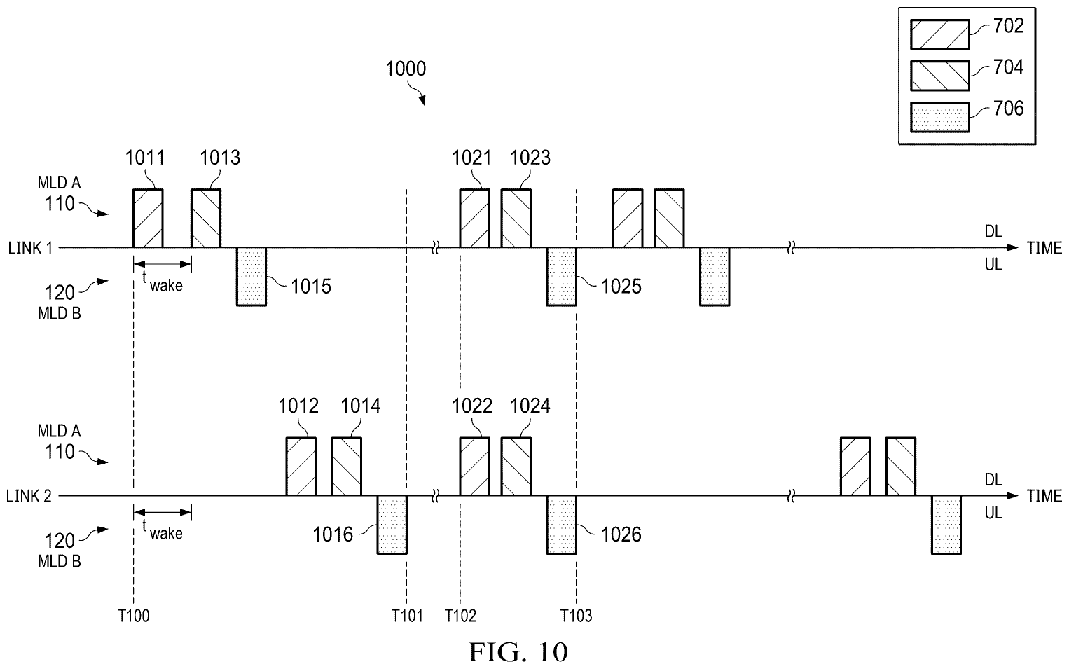

FIG. 10 shows a timeline of multi-link backscattering power communication 1000, according to some embodiments. Multi-link backscattering power communication 1000 operates in a similar manner as multi-link backscattering power communication 800. Multi-link backscattering power communication 1000, however, operates in joint mode, e.g., in an overlapping manner. In some embodiments, multi-link backscattering power communication 1000 may be performed in a non-overlapping manner.

As shown in FIG. 10, energy packet(s) 702 may or may not be transmitted simultaneously over links 1 and 2. As also shown in FIG. 10, in some embodiments, each exchange of data packets 704 and 706 on a particular link is preceded by energy packet(s) 702. For instance, FIG. 10 illustrates a first communication exchange beginning at time T100 and ending at T101 and a second communication exchange beginning at T102 and ending at T103. For instance, in the first communication exchange, MLD A 110 transmits a first energy packet 1011 on link 1 not overlapping in time with any other energy or data transmission (e.g., 1012-1016). The first communication exchange also includes a second energy packet 1012 transmitted on link 2 and not overlapping in time with any other energy or data transmission. Furthermore, the transmission of data packets 1013 and 1014 and the transmission of data packets 1015 and 1016 does not overlap in time with any other transmissions of either energy or data in the first communication exchange.

By contrast, the second communication exchange (between times T102 and T103) includes MLD A 110 transmitting an energy packet 1021 on link 1 overlapping in the time domain with transmitting another energy packet 1022 on link 2. Similarly, transmission of data packets 1023 and 1024 overlap in time on links 1 and 2, and transmission of data packets 1025 and 1026 overlap in time on links 1 and 2.

In some embodiments, during the multi-link energy and data exchange, the energy exchange and the data exchange are separated in frequency. For example, although not explicitly illustrated in FIG. 10, energy backscattering may be conducted at one (e.g., dedicated) channel (e.g., only link 1) of the multi-link channels.

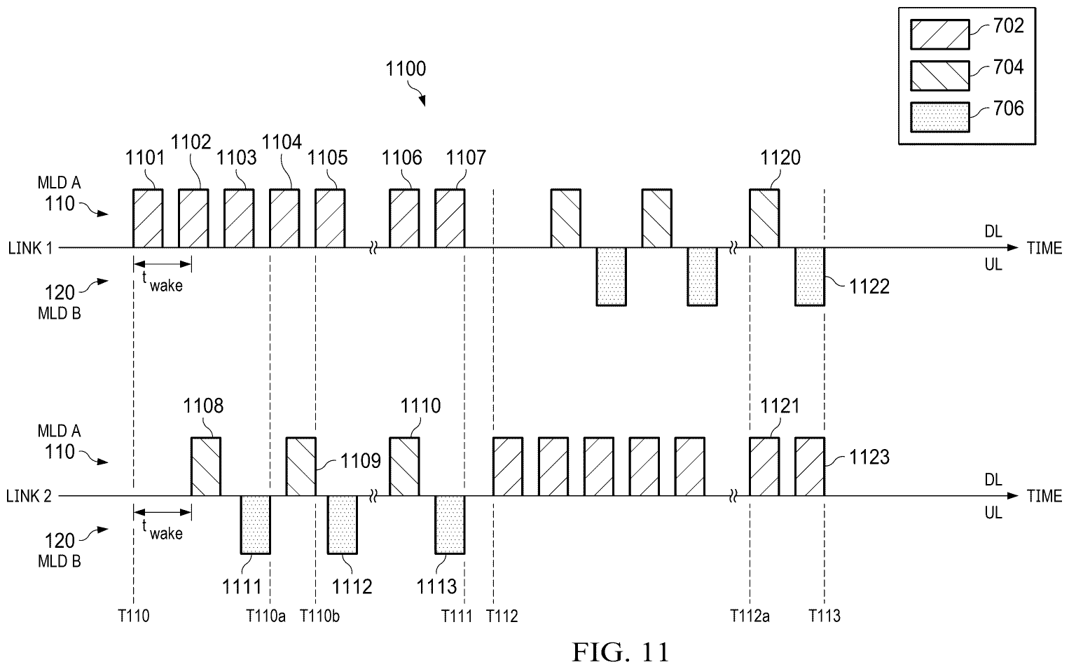

FIG. 11 shows a timeline of multi-link backscattering power communication 1100, according to some embodiments. Multi-link backscattering power communication 1100 operates in a similar manner as multi-link backscattering power communication 700. Multi-link backscattering power communication 1100, however, has energy and data communication exchanges separated in frequency.

In some embodiments, as shown in FIG. 11, the link transmitting energy may change over time. In some embodiments, the link transmitting energy may stay fixed (e.g., always link 1). The example of FIG. 11 illustrates two communication exchanges. One communication exchange begins at time T110 and ends at T111. The second communication exchange begins at time T112 and ends at time T113. In the first communication exchange, MLD A 110 transmits multiple energy packets 1101-1107 on link 1 and also transmits multiple data packets 1108-1110 on link 2 overlapping in time with the energy packets 1101-1107. MLD B 120 transmits multiple data packet 1111-1113 on link 2, separated in time from data packets 1108-1110 and overlapping in time with some of the energy packets 1103, 1105, and 1107. In the second communication exchange, the same is true, though link 1 and link 2 are switched. In one example, the energy packets 1101-1107, 1121, and 1123 are multiple instances of identical energy packets 702, though the scope of embodiments may include energy packets that are different from each other, such as by having varying lengths.

In some embodiments, multi-link backscattering power communication 1100 may be synchronized (e.g., where there is alignment between the backscatter energy backscattering transmitter timing and the communication timing), as shown in FIG. 11. For instance, between times T112a and T113, there is a data packet 1120 on link 1 aligning in time with an energy packet 1121 on link 2, and there is a data packet 1122 aligning in time with an energy packet 1123.

In some embodiments, multi-link backscattering power communication 1100 may be unsynchronized (e.g., where there is misalignment between the backscatter energy backscattering transmitter timing and the communication timing). For instance, between time T110a and time T110b, there is an energy packet 1104 and a data packet 1109 that partially overlap and, thus, do not align in the time domain.

In some embodiments, energy and data communication exchange may be performed in mixed-energy mode (e.g., backscattering conducted at any of the multi-link channels).

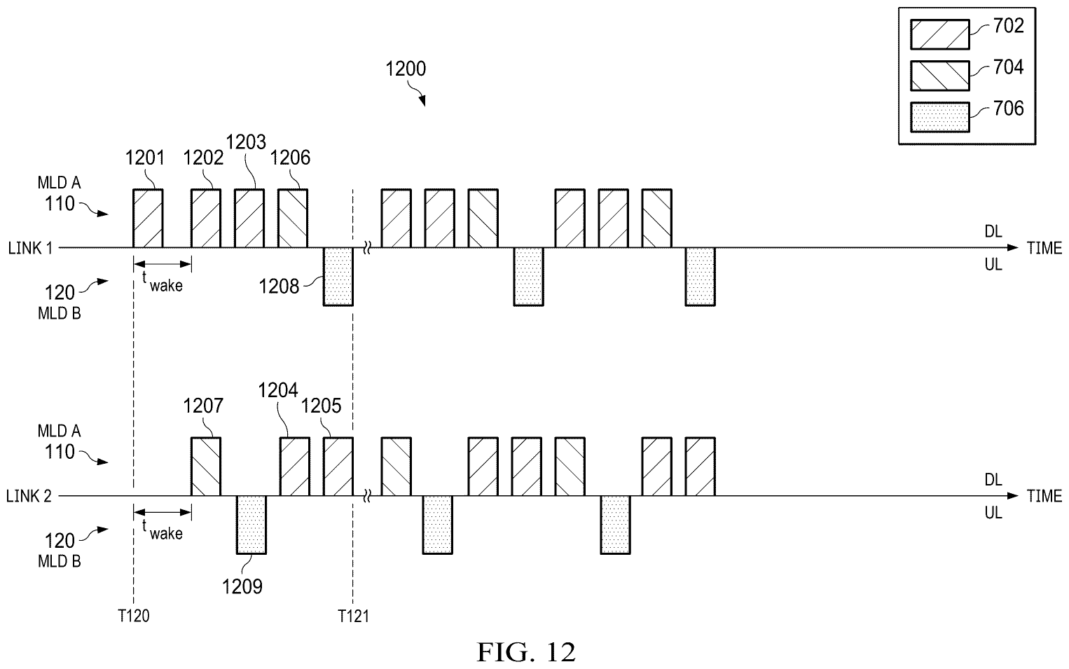

FIG. 12 shows a timeline of multi-link backscattering power communication 1200, according to some embodiments. Multi-link backscattering power communication 1200 operates in a similar manner as multi-link backscattering power communication 1100. Multi-link backscattering power communication 1200, however, operates in mixed-energy mode.

For instance, FIG. 12 illustrates a first communication exchange, beginning at time T120 and ending at time T121. During the first communication exchange, MLD A 110 transmits multiple energy packets 1201-1205 on both link 1 and link 2. Both MLD A 110 and MLD B 120 transmit respective data packets 1206, 1207 and 1208, 1209 on both links 1 and 2. Furthermore, in the first communication exchange, no downlink data packet overlaps with an uplink data packet, due to synchronization in the time domain parameters. However, during the first communication exchange, energy packet 1202 overlaps in the time domain with data packet 1207, and energy packets 1205 may overlap in the time domain with data packets 1209 and 1208.

As shown in FIG. 12, in some embodiments, multi-link backscattering power communication 1200 may be synchronized (e.g., where there is alignment between the backscatter energy backscattering transmitter timing and the communication timing). In some embodiments, multi-link backscattering power communication 1200 may be unsynchronized (e.g., where there is misalignment between the backscatter energy backscattering transmitter timing and the communication timing).

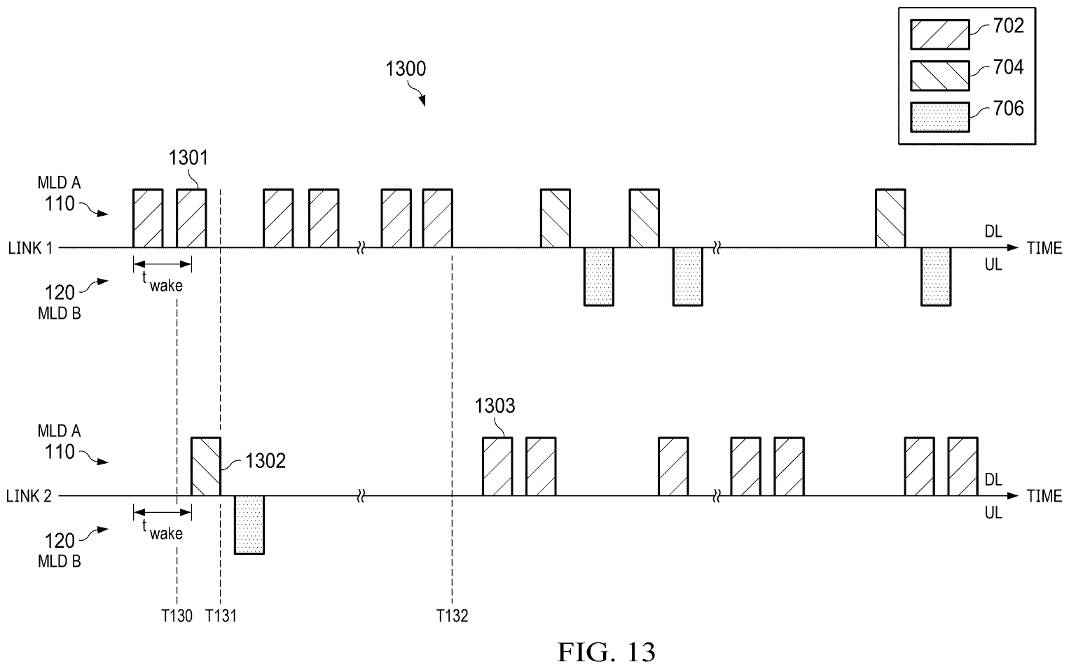

FIG. 13 shows a timeline of multi-link backscattering power communication 1300, according to some embodiments. Multi-link backscattering power communication 1300 operates in a similar manner as multi-link backscattering power communication 1100. Multi-link backscattering power communication 1300, however, is unsynchronized. For instance, between times T130 and T131, the energy packet 1301 and the data packet 1302 overlap in the time domain only partially and are, thus, not aligned in the time domain.

In some embodiments, as shown in FIG. 13, the link transmitting energy may change over time. In some embodiments, the link transmitting energy may stay fixed (e.g., always link 1). For instance, before time T132, MLD A 110 transmits energy packets (e.g., 1301) only on link 1, and after time T132, MLD A 110 transmits energy packets (e.g., 1303) only on link 2. In this example, MLD A 110 is configured to change which link it uses for transmitting energy from time to time.

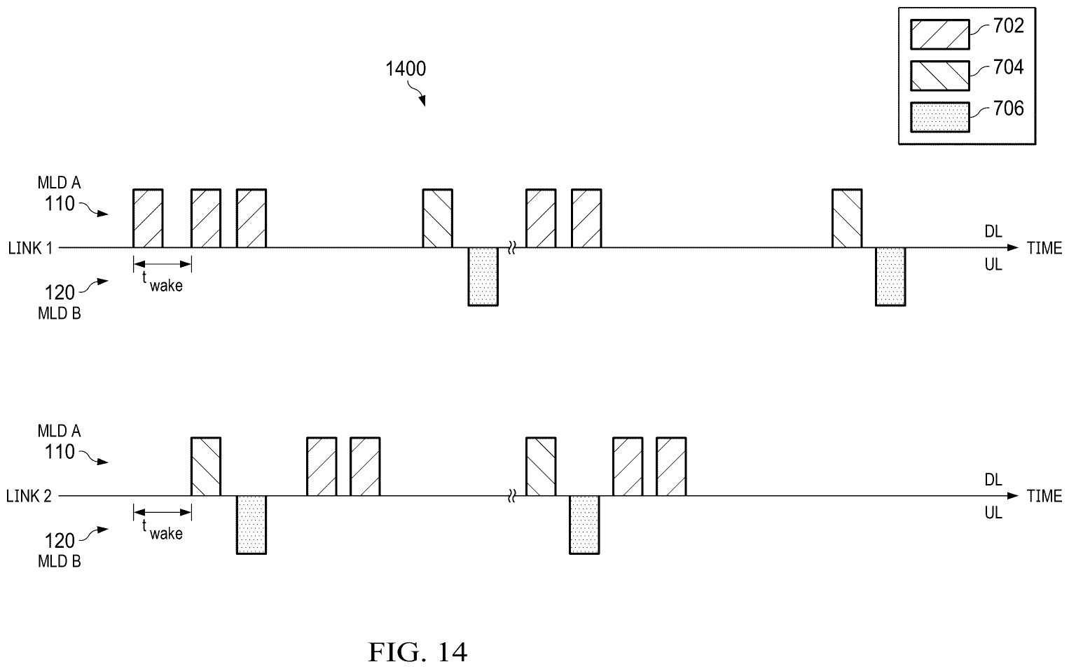

FIG. 14 shows a timeline of multi-link backscattering power communication 1400, according to some embodiments. Multi-link backscattering power communication 1400 operates in a similar manner as multi-link backscattering power communication 1200. Multi-link backscattering power communication 1300, however, is unsynchronized. For instance, transmissions of data and energy may or may not align in the time domain between links 1 and 2.

The multi-link backscattering power communications 700, 800, 900, 1000, 1100, 1200, 1300, and 1400, have been described with respect to FIG. 1, where data and energy flow from MLD A 110 to MLD B 120, and data flows from MLD B 120 to MLD A 110. In some embodiments, multi-link backscattering power communications 700, 800, 900, 1000, 1100, 1200, 1300, or 1400 may be implemented in a system where MLD A 110 provides energy and data to MLD B 120, and MLD B 120 provides data to MLD C (not shown). In some embodiments, multi-link backscattering power communications 700, 800, 900, 1000, 1100, 1200, 1300, or 1400 may be implemented in a system where MLD A 110 provides energy, and MLD B 120 provides data (e.g., 704) to MLD C, and MLD C provides data (e.g., 706) to MLD B. Other implementations are also possible.

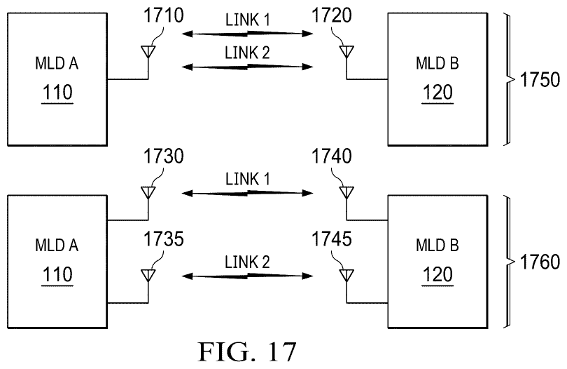

In some embodiments, all links of a multi-link energy and data exchange may share the same antenna or antenna array. In some embodiments, each link of the multi-link energy and data exchange may have a separate, dedicated antenna or antenna array. FIG. 17 illustrates example scenarios 1750, 1760, according to various embodiments. In scenario 1750, MLD A 110 includes antenna or antenna array 1710, and MLD B 120 includes antenna or antenna array 1720. The MLDs 110 and 120 use the same antennas or antenna arrays 1710, 1720 to accommodate both link 1 and link 2. By contrast, scenario 1760 illustrates MLD A 110 having multiple antennas or antenna arrays 1730, 1735. MLD B 120 includes antennas or antenna arrays 1740, 1745. MLDs 110 and 120 use antennas or antenna arrays 1730, 1740 to accommodate link 1 antennas or antenna arrays 1735, 1745 to accommodate link 2.

In some embodiments implementing multi-link backscattering power communications (e.g., 700, 800, 900, 1000, 1100, 1200, 1300, or 1400), the backscatter MLD may be implemented without a wake-up radio.

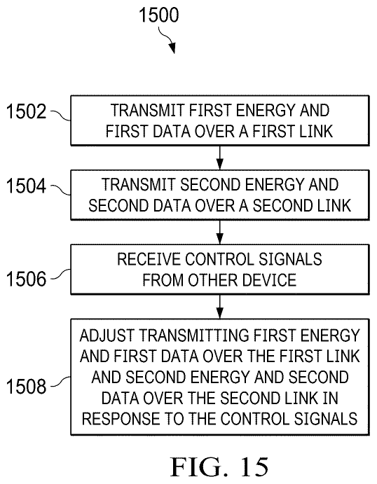

FIG. 15 illustrates an example method 1500, according to some embodiments. Method 1500 may be performed by an MLD, such as MLD A 110. In one example, MLD A 110 may be configured as described above, such as being configured to transmit energy and data over multiple links and to receive data over multiple links from another MLD, such as MLD B 120.

MLD A 110 may be configured in any appropriate manner, such as including a processor (e.g., processor 606 of FIG. 6) and a communication interface (e.g., communication circuit 604 of FIG. 6, operating as a transmitter and a receiver and transmitting and receiving through an antenna or an array of antennas). In one example, MLD A 110 may include a first STA A and a second STA B, corresponding to link 1 and link 2 respectively. Both of the STAs may communicate with a MAC endpoint (e.g., MAC endpoint 111) and an LLC layer (e.g., LLC layer 112). The processor (e.g., 606) may be configured to read computer-executable code to cause the MLD A 110 to perform the actions of method 1500.

MLD A 110 may be implemented as an integrated circuit (IC) on a single semiconductor chip, multiple semiconductor chips, on a system on-chip, or any other appropriate physical structure.

At action 1502, the MLD transmits first energy and first data over a first link. Examples of first energy and first data include instances of energy packet 702 and data packet 704, which may be transmitted over link 1 over an air medium.

At action 1504, the MLD transmits second energy and second data over a second link. Examples of second energy and second data include instances of energy packet 702 and data packet 704, which may be transmitted over link 2 over an air medium.

Actions 1502 and 1504 may be performed so that energy and data are synchronized or unsynchronized, so that the energy is transmitted over only a single link during a communication exchange or over both links during a communication exchange (e.g., mixed data and energy). Furthermore, the data may be transmitted in joint mode or duplicate mode. Examples of actions 1502 and 1504 are described above with respect to FIGS. 7-14. The energy and data transmitted at actions 1502 and 1504 may conform to a communication protocol, such as Wi-Fi, BLE, UWB, and/or the like.

Action 1506 includes receiving control signals from another device. In the example of FIG. 1, the other device may include MLD B 120. MLD B 120 may monitor its harvested energy, such as by monitoring a charging status of an energy storage device (e.g., backscattering energy collection circuit 610 FIG. 6) and may transmit control signals to MLD A 110 in response to the monitoring. For instance, the energy may be transmitted as a packet conforming to a communication protocol, a carrier wave conforming to a communication protocol, or other appropriate format conforming to a communication protocol.

The control signals received at action 1506 may include instructions to increase or decrease a level of power in the transmission of the energy, instructions for a timing of the transmission of the energy, instructions for a frequency of transmission of the energy (e.g., a channel or frequency band), beamforming instructions, an indication of a capability of MLD B 120, a channel measurement (e.g., RSSI), or any other operational setting and/or time domain, spatial domain (e.g., multiple antennas), and frequency domain parameter. The control signals may conform to a peer-to-peer protocol, a mesh network protocol, a Wi-Fi protocol, a BLE protocol, a UWB protocol, or other appropriate communication protocol.

Action 1508 includes adjusting transmitting the first energy and first data and/or adjusting the second energy and second data in response to the control signals. For instance, the MLD A 110 may adjust a time domain parameter, a frequency domain parameter, may adjust a spatial domain parameter (e.g., by selecting a different beam formation or antenna), may increase or decrease a level of energy in the first and/or second energy, and/or the like.

In one example, MLD A 110 may perform actions 1502-1508, and the feedback of action 1506 may be received from MLD B 120. The feedback may include control signals to cause MLD A 110 to transmit energy and/or data to a third device, such as in scenario 540 of FIG. 5. In such an instance, the third device may harvest energy and provide feedback to MLD B 120, which in turn provides feedback to MLD A 110.

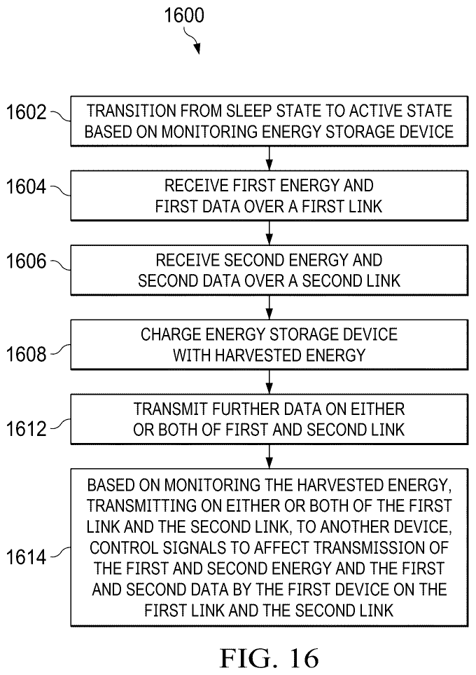

FIG. 16 is an illustration of an example method 1600, according to some embodiments. Example method 1600 may be performed by an MLD, such as MLD B 120 of FIG. 1. MLD B 120 may include multiple STAs, such as STAs C and D, corresponding to links 1 and 2 respectively. MLD B 120 may be configured the same as or similar to device 600 of FIG. 6, including a processor (e.g., processor 606) a communication interface (e.g., communication circuit 604 of FIG. 6, operating as a transmitter and a receiver and transmitting and receiving through an antenna or an array of antennas). Furthermore, MLD B 120 may include circuits that provide for sensing (e.g., sensing circuit 608) and circuits that provide for energy harvesting and power management (e.g., circuits 610, 620). The processor 606 may be configured to read computer-executable instructions to cause the MLD B 120 to perform method 1600.

MLD B 120 may be implemented as an integrated circuit (IC) on a single semiconductor chip, multiple semiconductor chips, on a system on-chip, or any other appropriate physical structure.

Action 1602 may include transitioning from a harvesting state (which may also be referred to as a sleep state) to an active state based on monitoring an energy storage device. For instance, the backscatter power transfer monitor and control circuit 620 may monitor the backscatter energy collection circuit 610 and may transition MLD B 120 from a harvesting state to an active state based on a threshold charge level of the backscatter energy collection circuit 610. The transition in action 1602 may also be performed in conjunction with a wakeup time (e.g., t_{wake}), such as described above with respect to FIGS. 7-14.

In the harvesting state, MLD B 120 may receive transmitted energy and may harvest energy and store that harvested energy. Receiving energy, harvesting energy, and storing harvested energy may also be performed during the active state.

Method 1600 may be performed in conjunction with another device (e.g., MLD A 110) performing method 1500. For instance, in one example, the actions 1604 and 1606 may be performed by receiving the first energy and first data and a second energy and second data, which was transmitted by MLD A 110 at actions 1502 and 1504.

Furthermore, MLD A 110 and MLD B 120 may have operating parameters, time domain parameters, frequency domain parameters, spatial domain parameters pre-programmed and/or pre-communicated so that during the active state, MLD B 120 may properly receive energy and data at actions 1604 and 1606.

Action 1608 includes charging the energy storage device with the harvested energy. For instance, the first energy and the second energy, received at actions 1604 and 1606, may be harvested and stored to an energy storage device (e.g., backscatter energy collection circuit 610), which may include a capacitor, a battery, and/or other appropriate energy storage device. In one example, MLD A 110 may be implemented as a battery-free device, which may have no battery and may rely on a capacitor or other device instead. In another example, MLD A 110 may be a battery-less device, which may have a small battery that may be supplemented with another device, such as a capacitor.

Action 1612 includes transmitting further data on either or both of the first link and the second link. For instance, in the examples of FIGS. 7-14, MLD B 120 may transmit instances of data packet 706. The data may be transmitted in joint mode or duplicate mode. The data transmitted at action 1612 may conform to a communication protocol, such as Wi-Fi, BLE, UWB, and/or the like. Also, the data transmitted at action 1612 may be synchronized with the energy transmitted on links 1 and links 2 or may be unsynchronized with the energy.

Action 1614 includes monitoring the harvested energy (e.g., the same as or similar to the monitoring at action 1602) and then transmitting control signals on either or both of link 1 and link 2. The control signals may be configured to affect transmission of the energy and data transmitted by MLD A 110 on links 1 and links 2. An example is described above with respect to actions 1506 and 1508 of FIG. 15, where MLD A 110 may receive control signals from MLD B 120 and may then adjust transmitting the energy and the data in response to the control signals.

In some embodiments, the feedback of action 1614 may be performed on behalf of a third device, such as in the scenario 540 of FIG. 5.

Some embodiments may advantageously combine multi-link operation and backscattering power communications.

Some embodiments may advantageously use one or more of the multi-link frequencies signals to operate as a backscattering transmitter as a source of energy.

Some embodiments are advantageously capable of operating in different backscattering modes, such as synchronous or asynchronous with separated or mixed-energy mode.

Some embodiments may advantageously have a backscattering energy collection unit capable of waking up the device and main radio without using a wakeup radio.

Some embodiments may advantageously have a multi-link over-the-air backscattering control information exchange protocol unit capable of sharing information with an energy transmitter MLD to allow for energy regulation.

Advantages of some embodiments may include enabling a robust, low-cost, and scalable way to provide power and enable IoT device's communication sensing and operation.

In some embodiments, the multi-link backscattering timing, control, and synchronization may enable increasing the range between the transmitter and the IoT device and/or provide higher data rates with higher-order modulation that may be leveraged to increase throughput or reduce power consumption.

Example embodiments of the present disclosure are summarized here. Other embodiments can also be understood from the entirety of the specification and the claims filed herein.
Example 1. An electronic device including: a communication interface; and a processor configured to: transmit first energy and first data over a first link, via the communication interface; and transmit second energy and second data over a second link, via the communication interface.
Example 2. The electronic device of example 1, where to transmit the first energy, the processor is configured to transmit a plurality of packets each having an empty payload.
Example 3. The electronic device of one of examples 1 or 2, where each of the packets is formatted according to a Wi-Fi protocol.
Example 4. The electronic device of one of examples 1 to 3, where each of the packets is formatted according to a 3rd Generation Partnership Project (3GPP) protocol.
Example 5. The electronic device of one of examples 1 to 4, where the first and second energy are transmitted using a plurality of identical packets or packets of varying length.
Example 6. The electronic device of one of examples 1 to 5, where the processor is configured to transmit third energy and third data over the first link, via the communication interface, where a first time between transmission of the first energy and the first data is longer than a second time between transmission of the third energy and third data.
Example 7. The electronic device of one of examples 1 to 6, where the processor is configured to negotiate the first time with a first device during a previous energy and data exchange with the first device.
Example 8. The electronic device of one of examples 1 to 7, where to transmit the first energy, the processor is configured to transmit a plurality of no-operation (NOP) packets.
Example 9. The electronic device of one of examples 1 to 8, where the first and second data are transmitted using one or more packets in one or more frames according to a first wireless communication protocol, and where the first and second energy are transmitted using one or more packets in one or more frames according to a second wireless communication protocol.
Example 10. The electronic device of one of examples 1 to 9, where the first wireless communication protocol is a WiFi protocol, and the second wireless communication protocol is a 3rd Generation Partnership Project (3GPP) protocol.
Example 11. The electronic device of one of examples 1 to 10, where to transmit the first energy, the processor is configured to transmit a plurality of packets each having a payload with dummy data.
Example 12. The electronic device of one of examples 1 to 11, where each of the payloads includes padding.
Example 13. The electronic device of one of examples 1 to 12, where the processor is configured to transmit the first energy as an unmodulated carrier wave.
Example 14. The electronic device of one of examples 1 to 13, where the processor is configured to transmit the first energy and first data over the first link before transmitting the second energy and second data over the second link.
Example 15. The electronic device of one of examples 1 to 14, where the processor is configured to transmit the first energy and first data over the first link without overlapping in a time domain with transmitting the second energy and second data over the second link.
Example 16. The electronic device of one of examples 1 to 15, where the first link and the second link overlap in a frequency domain.
Example 17. The electronic device of one of examples 1 to 16, where the processor is configured to transmit the first energy over the first link overlapping in a time domain with transmitting the second data over the second link.
Example 18. The electronic device of one of examples 1 to 17, where the processor is configured to transmit the first data over the first link overlapping in time with transmitting the second data over the second link.
Example 19. The electronic device of one of examples 1 to 18, where the processor is configured to transmit the first energy over the first link overlapping in a time domain with transmitting the second energy over the second link.
Example 20. The electronic device of one of examples 1 to 19, where the processor is configured to simultaneously transmit the first and second energy, and simultaneously transmit the first and second data.
Example 21. The electronic device of one of examples 1 to 20, where the processor is configured to: transmit the first energy and the first and second data during a first communication exchange; and after the first communication exchange, transmit third data over the first link, and fourth data over the second link, during a second communication exchange.
Example 22. The electronic device of one of examples 1 to 21, where the processor is configured to: transmit the first energy and the second data simultaneously during a first communication exchange; and after the first communication exchange, transmit the second energy and first data simultaneously during a second communication exchange.
Example 23. The electronic device of one of examples 1 to 22, where the second data is a duplicate of the first data.
Example 24. The electronic device of one of examples 1 to 23, where the processor is configured to transmit the first data over the first link and the second data over the second link in a joint mode.
Example 25. The electronic device of one of examples 1 to 24, where the processor is configured to divide a set of data into a first group of packets and a second group of packets, where the first data includes the first group of packets and the second data includes the second group of packets.
Example 26. The electronic device of one of examples 1 to 25, further including computer-executable code to cause the electronic device to: transmit the first energy and the first data separated in a frequency domain and overlapping in a time domain.
Example 27. The electronic device of one of examples 1 to 26, where the processor is configured to synchronize transmitting the first data and first energy with transmitting the second data and second energy.
Example 28. The electronic device of one of examples 1 to 27, where the processor is configured to transmit the first data and first energy asynchronously with transmitting the second data and second energy.
Example 29. The electronic device of one of examples 1 to 28, where the processor is configured to operate the first link unsynchronized with the second link.
Example 30. The electronic device of one of examples 1 to 29, where the processor is configured to operate the first link synchronously with the second link.
Example 31. The electronic device of one of examples 1 to 30, where the processor is configured to: receive third data over the first link; and receive fourth data over the second link.
Example 32. The electronic device of one of examples 1 to 31, where the processor is configured to exchange the first data with a first device over the first link and exchange the second data with the first device over the second link.
Example 33. The electronic device of one of examples 1 to 32, where the processor is configured to negotiate, with the first device, increasing or decreasing a power level of the first link.
Example 34. The electronic device of one of examples 1 to 33, where the processor is configured to negotiate, with the first device, a beam setting associated with the first link.
Example 35. The electronic device of one of examples 1 to 34, where the processor is configured to negotiate, with the first device, a frequency domain setting associated with the first link.
Example 36. The electronic device of one of examples 1 to 35, where the processor is configured to negotiate, with the first device, a time domain setting associated with the first link.
Example 37. The electronic device of one of examples 1 to 36, where the processor is configured to negotiate, with the first device, a starting time for transmitting the first energy over the first link.
Example 38. The electronic device of one of examples 1 to 37, where the processor is configured to receive data from the first device indicating capabilities of the first device.
Example 39. The electronic device of one of examples 1 to 38, where the processor is configured to exchange the first data with a first device over the first link and exchange the second data with the first device over the second link according to a peer-to-peer protocol.
Example 40. The electronic device of one of examples 1 to 39, where the processor is configured to exchange the first data with a first device over the first link and exchange the second data with the first device over the second link according to a mesh network protocol.
Example 41. The electronic device of one of examples 1 to 40, where the processor is configured to transmit the first energy before the first data, and transmit the second energy before the second data.
Example 42. The electronic device of one of examples 1 to 41, where the processor is configured to transmit the first energy before the first and second data, and transmit the second energy after the first and second data.
Example 43. The electronic device of one of examples 1 to 42, where the processor is configured to: receive one or more acknowledge packets for the first and second data; and receive no acknowledgement packet for the first and second energy.
Example 44. The electronic device of one of examples 1 to 43, where the electronic device is an access point (AP).
Example 45. An electronic device including: a communication interface; and a processor configured to: receive first energy and first data over a first link, via the communication interface; and receive second energy and second data over a second link, via the communication interface.
Example 46. The electronic device of example 45, where the processor is configured to: harvest energy from the received first and second energy; and charge a battery with the harvested energy.
Example 47. The electronic device of one of examples 45 or 46, where the processor is configured to: harvest energy from the received first and second energy; and charge an energy storage source with the harvested energy.
Example 48. The electronic device of one of examples 45 to 47, where the electronic device does not include a battery.
Example 49. The electronic device of one of examples 45 to 48, where the processor is configured to: harvest energy from the received first and second energy; and charge an energy storage device with the harvested energy.
Example 50. The electronic device of one of examples 45 to 49, where the processor is configured to: monitor the energy storage device; and cause the electronic device to transition from a sleep state to an active state in response to monitoring the energy storage device.
Example 51. The electronic device of one of examples 45 to 50, where the processor is configured to process the first and second data in the active state.
Example 52. The electronic device of one of examples 45 to 51, where the processor is configured to exchange the first data with a first device over the first link and exchange the second data with the first device over the second link.
Example 53. The electronic device of one of examples 45 to 52, where the processor is configured to negotiate, with the first device, a wakeup time for the electronic device.
Example 54. The electronic device of one of examples 45 to 53, where the processor is configured to negotiate, with the first device, a frequency domain setting associated with the first link.
Example 55. The electronic device of one of examples 45 to 54, where the processor is configured to negotiate, with the first device, a time domain setting associated with the first link.
Example 56. The electronic device of one of examples 45 to 55, where the processor is configured to negotiate, with the first device, a power level for the first link.
Example 57. The electronic device of one of examples 45 to 56, where the processor is configured to negotiate, with the first device, a spatial domain setting.
Example 58. The electronic device of one of examples 45 to 57, where the processor is configured to exchange third data with the first device to indicate capabilities of the first device.
Example 59. The electronic device of one of examples 45 to 58, where the processor is configured to exchange third data with a first device over a third link, which is different from the first link and the second link, and where the first device is different from a second device associated with the first link and the second link.
Example 60. The electronic device of one of examples 45 to 59, where the first, second, and third links are links according to a same wireless communication protocol.
Example 61. The electronic device of one of examples 45 to 60, where the processor is configured to receive the first energy and first data over the first link without overlapping in a time domain with receiving the second energy and second data over the second link.
Example 62. The electronic device of one of examples 45 to 61, where the first link and the second link overlap in a frequency domain and in a spatial domain.
Example 63. The electronic device of one of examples 45 to 62, where the processor is configured to receive the first energy over the first link overlapping in a time domain with receiving the second data over the second link.
Example 64. The electronic device of one of examples 45 to 63, where the processor is configured to receive the first data over the first link overlapping in time with receiving the second data over the second link.
Example 65. The electronic device of one of examples 45 to 64, where the processor is configured to receive the first energy over the first link overlapping in a time domain with receiving the second energy over the second link.
Example 66. The electronic device of one of examples 45 to 65, where the processor is configured to receive the first data over the first link and the second data over the second link in a duplicate mode.
Example 67. The electronic device of one of examples 45 to 66, where the processor is configured to receive the first data over the first link and the second data over the second link in a joint mode.
Example 68. The electronic device of one of examples 45 to 67, where the processor is configured to receive the first energy and the second data separated in a frequency domain, separated in a spatial domain, and overlapping in a time domain.
Example 69. The electronic device of one of examples 45 to 68, where the processor is configured to: synchronize receiving the second data and receiving the first energy.
Example 70. The electronic device of one of examples 45 to 69, where the processor is configured to: receive the second data and the first energy asynchronously between the first link and the second link.
Example 71. The electronic device of one of examples 45 to 70, where the processor is configured to operate the first link unsynchronized with the second link.
Example 72. The electronic device of one of examples 45 to 71, where the processor is configured to operate the first link synchronously with the second link.
Example 73. The electronic device of one of examples 45 to 72, where receiving the first energy includes receiving a first plurality of energy packets over the first link, where receiving the second energy includes receiving a second plurality of energy packets, where the processor is configured to transmit, via the communication interface, one or more acknowledgment packets to acknowledge the first and second data, and to not transmit any acknowledgement packets to acknowledge any of the first and second pluralities of energy packets.
Example 74. An electronic device including: a communications circuit configured to receive first energy and first data over a first link and to receive second energy and second data over a second link; and an energy collection circuit configured to: harvest the first and second energy received by the communications circuit over the first link and the second link, and power the communications circuit using the harvested energy.
Example 75. The electronic device of example 74, where the energy collection circuit is configured to charge a battery using the harvested energy.
Example 76. The electronic device of one of examples 74 or 75, where the device does not include a battery.
Example 77. The electronic device of one of examples 74 to 76, where the energy collection circuit is configured to charge an energy storage source using the harvested energy.
Example 78. The electronic device of one of examples 74 to 77, where the energy collection circuit is configured to power the communications circuit using direct current (DC) voltage.
Example 79. The electronic device of one of examples 74 to 78, where the energy collection circuit is configured to store the harvested energy in an energy storage device, and where the communications circuit is configured to transition from a sleep mode to an active state responsive to an energy level of the energy storage device.
Example 80. The electronic device of one of examples 74 to 79, further including: a control circuit, communicatively coupled to the communications circuit and the energy collection circuit, where the control circuit is configured to: monitor the harvested energy; and responsive to monitoring the harvested energy, cause the communications circuit to transmit on either or both of the first link and the second link, to a first device, control signals to affect transmission of the first and second energy and the first and second data by the first device on the first link and the second link.
Example 81. The electronic device of one of examples 74 to 80, where the control signals include instructions to increase or decrease a level of power in the transmission of the first and second energy.
Example 82. The electronic device of one of examples 74 to 81, where the control signals include instructions for a timing of the transmission of the first and second energy.
Example 83. The electronic device of one of examples 74 to 82, where the control signals include instructions for one or more frequencies of the transmission of the first and second energy.
Example 84. The electronic device of one of examples 74 to 83, where the control signals include instructions for beamforming for the transmission of the first and second energy.
Example 85. The electronic device of one of examples 74 to 84, where the control signals include an indication of capabilities of the first device.
Example 86. The electronic device of one of examples 74 to 85, where the control signals conform to a peer-to-peer protocol.
Example 87. The electronic device of one of examples 74 to 86, where the control signals conform to a mesh network protocol.
Example 88. The electronic device of one of examples 74 to 87, where the control signals conform to a Wi-Fi protocol.
Example 89. The electronic device of one of examples 74 to 88, where the control signals conform to an IEEE 811.15.4 protocol.
Example 90. The electronic device of one of examples 74 to 89, where the communications circuit is configured to transmit an acknowledgment for the first and second data and is configured to not transmit an acknowledgment for the first or second energy.
Example 91. The electronic device of one of examples 74 to 90, where the electronic device is implemented on a semiconductor die.
Example 92. The electronic device of one of examples 74 to 91, where the electronic device is implemented as a system on-chip (SOC).

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. An electronic device comprising:
a communication interface; and
a processor configured to:
transmit first energy and first data over a first link, via the communication interface; and
transmit second energy and second data over a second link, via the communication interface.

2. The electronic device of claim 1, wherein the processor is configured to transmit third energy and third data over the first link, via the communication interface, wherein a first time between transmission of the first energy and the first data is longer than a second time between transmission of the third energy and third data.

3. The electronic device of claim 1, wherein the processor is configured to transmit the first energy and first data over the first link without overlapping in a time domain with transmitting the second energy and second data over the second link.

4. The electronic device of claim 1, wherein the processor is configured to transmit the first energy over the first link overlapping in a time domain with transmitting the second data over the second link.

5. The electronic device of claim 1, wherein the processor is configured to transmit the first data over the first link overlapping in time with transmitting the second data over the second link.

6. The electronic device of claim 1, wherein the processor is configured to simultaneously transmit the first and second energy and simultaneously transmit the first and second data.

7. The electronic device of claim 1, wherein the processor is configured to:
transmit the first energy and the first and second data during a first communication exchange; and
after the first communication exchange, transmit third data over the first link, and fourth data over the second link, during a second communication exchange.

8. The electronic device of claim 1, wherein the processor is configured to:
transmit the first energy and the second data simultaneously during a first communication exchange; and
after the first communication exchange, transmit the second energy and first data simultaneously during a second communication exchange.

9. The electronic device of claim 1, wherein the processor is configured to operate the first link unsynchronized with the second link.

10. The electronic device of claim 1, wherein the processor is configured to operate the first link synchronously with the second link.

11. An electronic device comprising:
a communication interface; and
a processor configured to:
receive first energy and first data over a first link, via the communication interface; and
receive second energy and second data over a second link, via the communication interface.

12. The electronic device of claim 11, wherein the processor is configured to:
harvest energy from the received first and second energy; and
charge an energy storage source with the harvested energy.

13. The electronic device of claim 11, wherein the processor is configured to:
monitor an energy storage device; and
cause the electronic device to transition from a sleep state to an active state in response to monitoring the energy storage device.

14. The electronic device of claim 11, wherein the processor is configured to exchange the first data with a first device over the first link and exchange the second data with the first device over the second link.

15. The electronic device of claim 14, wherein the processor is configured to negotiate, with the first device, a spatial domain setting.

16. The electronic device of claim 11, wherein the processor is configured to receive the first data over the first link and the second data over the second link in a duplicate mode.

17. The electronic device of claim 11, wherein the processor is configured to receive the first data over the first link and the second data over the second link in a joint mode.

18. The electronic device of claim 11, wherein receiving the first energy comprises receiving a first plurality of energy packets over the first link, wherein receiving the second energy comprises receiving a second plurality of energy packets, wherein the processor is configured to transmit, via the communication interface, one or more acknowledgment packets to acknowledge the first and second data, and to not transmit any acknowledgement packets to acknowledge any of the first and second pluralities of energy packets.

19. An electronic device comprising:
a communications circuit configured to receive first energy and first data over a first link and to receive second energy and second data over a second link; and
an energy collection circuit configured to:
harvest the first and second energy received by the communications circuit over the first link and the second link, and
power the communications circuit using the harvested energy.

20. The electronic device of claim 19, wherein the energy collection circuit is configured to power the communications circuit using direct current (DC) voltage.

21. The electronic device of claim 19, wherein the energy collection circuit is configured to store the harvested energy in an energy storage device, and wherein the communications circuit is configured to transition from a sleep mode to an active state responsive to an energy level of the energy storage device.

22. The electronic device of claim 19, further comprising:
a control circuit, communicatively coupled to the communications circuit and the energy collection circuit, wherein the control circuit is configured to:
monitor the harvested energy; and
responsive to monitoring the harvested energy, cause the communications circuit to transmit on either or both of the first link and the second link, to a first device, control signals to affect transmission of the first and second energy and the first and second data by the first device on the first link and the second link.
